(19) United States
(12) Patent Application Publication
(10) Pub. No.: US 2002/0042734 A1
(43) Pub. Date: Apr. 11, 2002

(54) Method of providing fresh fish distribution support information and device for providing fresh fish distribution support information

(75) Inventors: Asami Shikida, Ishikawa-ken (JP); Yoichi Ohashi, Ishikawa-ken (JP)

Correspondence Address: Brinks Hofer Gilson & Lione, P.O. Box 10395, Chicago, IL, 60610, US

(73) Assignee: Kanazawa Institute of Technology

(21) Appl. No.: 09/894,235

(22) Filed: Jun. 27, 2001

(30) Foreign Application Priority Data
Jun. 28, 2000 (JP) 2000-236267

(51) Int. Cl. G06F 7/00; G06F 17/60

(52) U.S. Cl. 705/10; 705/28

(57) ABSTRACT

To utilize fish catch microdata obtained on a daily basis at fishing grounds for fresh fish, and to rapidly and accurately transmit the fish catch information to the various consumer markets via a computer communications network, so as to promote distribution and commercial transactions that rapidly adjust to changes in supply and demand, and so as to rationalize and stabilize the market price of fresh fish, while preventing a decline in the degree of freshness of the fish. Having fisheries input to a server fish catch microdata via a computer communications network, converting this data to a database and storing it on a server, so that when a fishery, distributor, consumer, or the like seek fresh fish information, they are asked to input to the server the selection conditions for the desired information via a computer communications network, and the fresh fish information conforming to these conditions is read from said database, and transmitted to the party desiring the fresh fish information.

### BACKGROUND OF THE INVENTION

This invention relates to the field of technology for providing information on fresh fish to interested parties rapidly and accurately, by means of a computer communications network system (the Internet), thereby contributing to the catching (or production) of fish.

That is to say, the present invention relates to a method and device for providing fresh fish distribution support information, by gathering fish catch microdata for various types of fish, or transaction (sales) result data for various types of fish in fresh fish markets at various locales, via a computer communications network, putting these data to database format, recording and storing these data on a server as a fresh fish information database, and at the same time, providing information on fresh fish that conforms to the requirements of fresh fish producers, distributors, and consumers interested in this information, based on said fresh fish information database, via a computer communications network.

In this application, the terms “fresh fish,” “fish catch microdata,” “producer,” and “distributor” have the following meanings.

“Fresh fish” is a generic term referring to various types of fresh fish, shellfish, and marine products, as well as processed products thereof.

“Fish catch microdata” refers to groups of data recorded for each individual fisherman, and includes the name of the fishery (fisherman), the fisheries cooperative, date of landing, species of fish, description (size of fish), fishing method (fixed net, gill net, straight net, trawl net, seine, rod-and-reel, cuttlefish fishing, etc.), volume of catch, monetary value of catch, and the like, for each fish that is caught and landed, and these data are gathered by each fishery or by the fisheries cooperative to which the fishery belongs.

“Producer” is a generic term referring to a fishery or fisheries cooperative (hereinafter abbreviated as “fishing co-op”) to which a fishery belongs or which collects and loads the fresh fish.

“Distributor” is a generic term referring a broker, consignee, wholesaler, retailer, etc.

As has been well known heretofore, when fish are caught, they generally proceed from the producer to the consumer via a distribution channel, as shown in FIG. 15. That is to say, the freshly caught fish are first auctioned by a producer (fishery or fishing co-op) 151a at the market of origin 151 to a production side broker 151b. Then the fresh fish are auctioned by the production side broker 151b to a consumption side broker 152b at a consumption side market 152 through a consignee 152, and the fresh fish are sold by the consumption side broker 152b to a retailer 153a such as a marine products retailer or a volume sales shop in the final consumer market 153, and the consumer 153b purchases the fresh fish from the retailer 153a. The role of volume sales shops has become much greater in the distribution of fresh fish.

What must be observed here is that the actual state of communication and exchange of fresh fish information in the above-described conventional fresh fish distribution process is such that most of the information is exchanged directly between the persons involved in the transactions at the place of the individual transactions as the fresh fish are successively sold, and the content goes no further than the local information directly pertaining to the persons involved. Information about the place where the fresh fish are produced, or transaction information from other markets, or other related fresh fish information spanning the entire fresh fish distribution process cannot be rapidly and accurately obtained. As a result, a large number of transactions rely on past experience and intuition, so that it is possible for transactions to be conducted such that the balance of supply and demand is lost, or extremely high-priced bidding ensues, or conversely, the price of the fresh fish drops excessively due to the phenomenon of “sharp drop in sales price caused by sudden oversupply.”

Furthermore, in the past, when fresh fish were landed and auctioned at the market of origin, the fish catch microdata pertaining to the fresh fish were collected. This fish catch microdata represented enormous groups of data (e.g., using Ishikawa Prefecture as an example, there are over 7,000 data groups per day, and about 1,500,000 data groups per year), but the fish catch microdata is used by the fishing co-op in executing payment to the fishery according to each fishery's catch, and for no other purpose. It should be noted that progress is being made in putting the fish catch microdata in electronic form.

On the other hand, data mining has long been known as a data processing technique. “Data mining” is a data processing technique for finding patterns, trends, and correlations hidden in large and complex data groups that do not at first appear to be in any order, without involving a lot of labor. However, in the past, there were no technical concepts for analyzing fish catch microdata with data mining techniques and using the resulting fish catch forecast data to produce fresh fish distribution support information.

Moreover, in the past, distributors or consumers who obtained fresh fish were almost always unable to easily confirm right away the information on the origin of the fresh fish (place caught, fishing co-op at the place caught, the fishery that caught the fish, description, date caught, date shipped, etc.). However, there were also no technical concepts for making it possible to easily know background information on the fresh fish based on fish catch microdata, so as to enhance the source and quality assurance as well as the health administration support functions, by using this background information on the fish.

The involvement of volume sales shops in the end consumer market is great, but the delivery conditions required by the volume sales shops are as follows.

(1) Delivery at a certain time

(2) Delivery of a certain volume

(3) At a certain price (low price)

(4) With certain specifications

(5) An assortment of products is possible

Of course, due to the fact that there are great fluctuations in price and inconsistencies in size since the volume of the domestic wild-caught fish catch is unstable, the aforesaid conditions do not readily apply to domestic wild-caught fish, but since a stable supply of fresh fish is required for an assortment of products in shops, the majority of the fresh fish catch has been shifted to the principal consumption markets that are far removed from the production site. Consequently, the degree of freshness of the fish has declined and there has been a drop in the price of the fish as a product. Moreover, the shipping costs have risen enormously, resulting in a loss of profits from fish which should garner a high price as a product, and in particular, there has been a loss in profits for the producers.

On the other hand, there is a great latent demand for fresh fish, an indispensable part of Japanese cuisine, and Japanese consumers are greatly concerned about the supply, quality, and price of fresh fish. At the same time, however, the general perception among Japanese consumers regarding fresh fish is that the market price of fresh fish is considerably higher than other prices, so it is necessary to maintain the freshness of the fish and to find a rational way to reduce the price of fresh fish, in order to increase the desire on the part of consumers to buy more.

In the past, means have been sought to find a rational way to reduce and stabilize the market price of fresh fish, and to restore the inherent high value of fresh fish based on its degree of freshness, so as to enhance the profits of producers, but outstanding results have yet to be realized. The main factor that makes it difficult to solve this problem lies in the basic nature of the fisheries industry, namely, that the planning involved in catching wild fish and shellfish is governed by nature, and does not always go as intended. However, it is also thought that another significant factor is the lack of prompt communication and exchange of a wide range of fresh fish information among producers, distributors, and consumers. That is to say, it is thought that the speedy and accurate communication and exchange of fresh fish information, which is closely related to decreases in freshness and to market price determination, is very undeveloped and insufficient, resulting in a lack of transparency and rationality in the determination of prices for fresh fish.

### BRIEF SUMMARY OF THE INVENTION

The object of this invention is to make it possible to collect daily catch data and transaction (sales) result data for fresh fish via a computer communications network, and process these data to create a database for the various types of fresh fish data, so that producers, distributors, and consumers of fresh fish can promptly obtain the required information on fresh fish by accessing a computer communications network, and in particular, to make it possible to rapidly and accurately transmit fish catch information from the production sites to each consumer market. Accordingly, the aim is to promote rational and efficient distribution and commercial transactions that rapidly adjust to changes in supply and demand, so as to rationally reduce and stabilize the market price of fresh fish, without sacrificing the freshness of the fish, and also to enhance profits for the fisheries industry, by promoting reasonable price determination for fish while maintaining a high level of freshness.

In addition, this invention aims to create a fresh fish information database based on fish catch microdata obtained moment-by-moment from the market of origin and the most current raw data, utilizing transaction (sales) result data obtained moment-by-moment from fresh fish markets at various locales, to bring about the communication and exchange of highly reliable fresh fish information based on this fresh fish information database.

Furthermore, this invention aims to support the high reliability of fresh fish information that is communicated and exchanged, so that there is no false data input or data tampering by unauthorized persons when the fish catch microdata and transaction (sales) result data is entered into the server via a computer communications network.

Moreover, this invention aims to prevent the leakage of the individual base data (microdata) of fisheries or distributors in the process of accessing a fresh fish information database based on fish catch microdata and transaction (sales) result data formed from individual base data.

Also, this invention aims to make it possible for distributors or consumers who obtain fresh fish to immediately and readily confirm background information on the fish, and to enhance the source and quality assurance of the fish and to enhance the health administration support functions, and to greatly increase the added value through the use of this background information.

Another aim of the present invention is to promote planned and rational fish catching and distribution, to support more stable and reliable determination of fresh fish prices, and also to prevent overfishing so as to protect fishery resources and to promote the effective utilization thereof, by using the very large volume of fish catch microdata accumulated in the past, and to derive fresh fish forecast information such as fish catch volume forecast information and price forecast information.

Yet another aim of the present invention is to invoice the fisheries, distributors, and consumers when providing highly effective fresh fish information, and to plan for the fuller development of this information providing business, and the income from these billings will help to enhance the income of the fisheries.

As recited above, the object of the first stage of this invention is to obtain the most current fresh fish information that reflects the actual status of the fishing grounds and consumer markets, from the fishing grounds to the end consumer markets, via a computer communications network. Looking to the future, the object of the present invention is to bring about fresh fish transactions on the network, to bring about fresh fish futures trading on the net market, and to create a virtual fish catch and virtual fresh fish market on the network.

In order to solve these problems and achieve these objectives, this invention uses the following method and device. That is to say, as a method for rapidly providing fresh fish source information to a wide range of markets, this invention provides fresh fish distribution support information through the steps of guiding fresh fish producers to have them input fish catch microdata via a computer communications network, converting the fish catch microdata input and collected from fresh fish producers to database format and recording and storing it on a server as a fresh fish information database, guiding parties desiring fresh fish information (persons seeking information pertaining to fresh fish) to have them input selection conditions for the desired information via a computer communications network, searching for and reading from the fresh fish information database the fresh fish information that conforms to the selection conditions, and transmitting to said parties desiring fresh fish information the fresh fish information that was read out from the server.

As a method for broadly and rapidly making available information on the actual status of markets where fresh fish are traded, this invention provides fresh fish market information as distribution support information through the steps of guiding fresh fish distributors to have them input fresh fish transaction result data via a computer communications network, converting the fresh fish transaction result data input and collected from fresh fish distributors and recording and storing it on a server as a fresh fish information database, guiding parties desiring fresh fish information input selection conditions for the desired information via a computer communications network, searching for and reading from the fresh fish information database the fresh fish information that conforms to the selection conditions, and transmitting to said parties desiring fresh fish information the fresh fish information that was read out from the server.

Furthermore, in order to maintain the reliability of the input data, a password of a fresh fish producer is needed to enter fish catch microdata, and input is denied, based on this password, if the person entering the data is found not to be a person authorized to enter data. Likewise, a password of a fresh fish distributor is needed to enter fresh fish transaction result data, and input is denied if the person entering the data is found not to be a person authorized to enter data.

Moreover, since the fish catch microdata that forms the foundation of the database is personal information, the fish catch microdata input and collected from fresh fish producers is divided into limited access data and public domain data, converted to database format and recorded and stored on a server as a fresh fish information database, and the addition of the password of the party desiring the fresh fish information is required in order to enter the selection conditions of the desired information, and a determination is made, based on the password, whether or not to provide fresh fish information containing limited access data to the party desiring the fresh fish information.

Likewise, the fresh fish transaction result data input and collected from fresh fish distributors is also divided into limited access data and public access data, converted to database format and recorded and stored on a server as a fresh fish information database, and the addition of the password of the party desiring the fresh fish information is required in order to enter the selection conditions of the desired information, and a determination is made, based on the password, whether or not to provide fresh fish information containing limited access data to the party desiring the fresh fish information.

Since the fresh fish information based on fish catch microdata and fresh fish transaction result data is very valuable and useful, it is thought that a reasonable fee should be charged for providing this information. Accordingly, the fish catch microdata input and collected from fresh fish producers is divided into for-fee data and no-fee data, converted to database format, recorded and stored on a server as a fresh fish information database, and invoices are processed, according to the category of the party desiring the fresh fish information, for the fresh fish information that is searched and read from the fresh fish information database.

Likewise, the fresh fish transaction result data input and collected from fresh fish distributors is divided into for-fee data and no-fee data, converted to database format, recorded and stored on a server as a fresh fish information database, and invoices are processed, according to the category of the party desiring the fresh fish information, for the fresh fish information that is searched and read from the fresh fish information database.

Furthermore, in order for a distributor or consumer in a market removed from the production site to know the source and quality of the obtained fresh fish, and in order to contribute to the subsequent ordering, a fresh fish identification tag with a fresh fish identification tag code is attached to each fish, and parties desiring to find out information on the background of each fish input the fresh fish identification tag code attached to each fish via a computer communications network, and search and read out the relevant fish catch microdata from the fresh fish information database with the fresh fish identification tag code as a link code, and the fresh fish information containing the fish catch microdata is read out from the server and transmitted to the party desiring the fresh fish information.

Likewise, the relevant fresh fish transaction result data for an individual fish are searched and read out from the fresh fish information database with the fresh fish identification tag code as a link code, and the fresh fish information containing this fresh fish transaction result data that was read out is output from the server and transmitted to the party desiring the fresh fish information.

Moreover, in an attempt to provide forecast data for catch volume and prices, based on fish catch microdata, fresh fish forecast data is produced by analyzing data based on fish catch microdata collected and accumulated from producers, and this forecast data is converted to database format and recorded and stored on a server as fresh fish forecast data from the fresh fish information database. This fresh fish forecast data is read out via a computer communications network to parties desiring forecast information on fish catch and prices, and transmitted to persons desiring fresh fish information. Also, fresh fish forecast data is produced by analyzing fish catch microdata by data mining.

At the same time, the main component of a device that implements the method of this invention is a server connected to the data terminals of a plurality of producers, distributors, or consumers via a computer communications network. This server has as its key parts an output control device that outputs data that guides the input of fish catch microdata or fresh fish transaction result data to said data terminals, an input control device for inputting the fish catch microdata or fresh fish transaction result data transmitted from these data terminals, a CPU that converts said fish catch microdata or fresh fish transaction result data to various types of fresh fish information databases, operating according to a database building program installed in a memory device in advance, and a memory device for recording and storing the database building program as well as the fresh fish information databases.

Furthermore, this server has as its key parts an output control device that outputs data that guides the input of the passwords of producers as well as fish catch microdata or data that guides the input of passwords of distributors as well as fresh fish transaction result data to the data terminals, an input control device for inputting passwords as well as fish catch microdata or fresh fish transaction result data transmitted from these data terminals, a CPU that determines if said producers or distributors are authorized to enter data, based on passwords, operating according to an access control program installed in the memory device in advance, and a memory device containing the fresh fish information database based on the fish catch microdata or the fresh fish transaction result data as well as the access control program.

Moreover, the server is connected to the data terminals of a plurality of parties desiring fresh fish information via a computer communications network, and has as its key parts an output control device that outputs data that guides the input of selection conditions for the desired data to these data terminals and that outputs fresh fish information that conforms to these selection conditions, an input control device that inputs the selection conditions of the desired information transmitted from these data terminals, a CPU that searches and reads out the fresh fish information that conforms to the selection conditions, operating according to an access control program installed in the memory device in advance, and a memory device containing the search program as well as the fresh fish information database.

In addition, the server has as its key parts an output control device for outputting data that guides the input of the passwords of parties desiring fresh fish information as well as the selection conditions for the desired information to the data terminals of parties desiring fresh fish information and outputs fresh fish information conforming to these selection conditions to parties desiring fresh fish information, an input control device for inputting the passwords as well as the selection conditions for the desired information transmitted from these data terminals, a CPU that determines the category of the parties desiring fresh fish information and whether or not they are authorized to search, based on a password, according to an access control program installed in the memory device in advance, and that searches and reads out from a fresh fish information database the fresh fish information conforming to the selection conditions and the category of the party desiring the fresh fish information, by means of a search program installed in a memory device in advance, and a memory device in which are installed said access control program, a search program, and a fresh fish information database.

Also, a server connected to data terminals of a plurality of parties desiring fresh fish information via a computer communications network has as its key parts an output control device that outputs data that guides the input of the passwords of parties desiring fresh fish information to these data terminals as well as the selection conditions for the desired information, and that outputs fresh fish information that conforms to the selection conditions to the parties desiring fresh fish information, an input control device that inputs the passwords transmitted from the data terminals as well as the selection conditions for the desired information, a CPU that determines the category of the parties desiring fresh fish information and whether or not they are authorized to search, based on a password, according to an access control program installed in the memory device in advance, and that computes invoices for the fresh fish information read out as described above, according to the category of the party desiring fresh fish information, by means of an invoicing program installed in advance in a memory device, based on the searching and reading out from a fresh fish information database fresh fish information conforming to said selection conditions and the category of the party desiring fresh fish information, and a memory device in which are installed said access control program, a search program, an invoicing program, and a fresh fish information database.

Moreover, in order to provide fish catch forecast information based on fish catch microdata, there are provided a memory device in which is installed in advance a forecasting program that analyzes and generates fish catch microdata, and a CPU for reading out fresh fish forecast information, operating according to the forecasting program, in a server connected to the data terminals of producers or distributors as parties desiring fresh fish information via a computer communications network.

### BRIEF DESCRIPTION OF THE DRAWINGS

FIG. 1 is a block diagram of a system providing fresh fish distribution support information that includes a device for providing fresh fish distribution support information relating to this invention;

FIG. 2 is a block diagram showing the configuration of a server in this system;

FIG. 3 is a flow chart of a method of providing fresh fish distribution support information showing an example of this invention;

FIG. 4 is a basic input data overview chart showing an example of the basic input data required for the embodiment of this invention;

FIG. 5 is a fish catch microdata overview chart showing an example of the fish catch microdata required for the embodiment of this invention;

FIG. 6 is a fresh fish transaction (sales) result data overview chart showing an example of fresh fish transaction result data used in the embodiment of this invention;

FIG. 7 is an overview chart of databases of information offered (output) showing an example of basic databases of fresh fish information provided in accordance with this invention;

FIG. 8 is a sketch of a screen showing an example of a screen appearing on the display of a data terminal of the system of FIG. 1 when the method of providing fresh fish distribution support information of this invention is implemented;

FIG. 9 is a flow chart showing the flow from the generation to the utilization of fresh fish distribution support information provided in accordance with this invention;

FIG. 10 is a graph showing the relationship between the day of the catch, the volume of the catch, and the unit price, based on an example of fresh fish microdata;

FIG. 11 is a graph showing the relationship between the length of the fish and the unit price, based on an example of fish catch microdata;

FIG. 12 is a graph showing the relationship between the fish catch volume for 1 day and the unit price, based on an example of fish catch microdata;

FIG. 13 is a graph showing the relationship between the fish catch volume for 10 days and the unit price, based on an example of fish catch microdata;

FIG. 14 is a graph showing the coefficient of correlation between the total number of days of fish catch volume and the unit price, based on fish catch microdata; and

FIG. 15 is a chart showing conventional distribution channels.

### DETAILED DESCRIPTION OF THE INVENTION

One fundamental embodiment of this invention is a method of providing fresh fish distribution support information, wherein information pertaining to fresh fish is collected and processed via a computer communications network and provided as distribution support information via a computer communications network, said method characterized in comprising the steps of guiding fresh fish producers to have them input fish catch microdata of various parties via a computer communications network, converting the fish catch microdata input and collected from fresh fish producers to database format and recording and storing it on a server as at least part of a fresh fish information database, guiding parties desiring fresh fish information to have them input selection conditions for the desired information via a computer communications network, searching for and reading from the fresh fish database the fresh fish information that conforms to the selection conditions, and transmitting to said parties desiring fresh fish information the fresh fish information that was read out from the server.

Another fundamental embodiment of this invention is a method of providing fresh fish distribution support information, wherein information pertaining to fresh fish is collected and processed via a computer communications network and provided as distribution support information via a computer communications network, said method comprising the steps of guiding fresh fish distributors to have them input fresh fish transaction result data of various parties via a computer communications network, converting the fresh fish transaction result data input and collected from fresh fish distributors to database format and recording and storing it on a server as at least part of a fresh fish information database, guiding parties desiring fresh fish information to have them input of selection conditions for the desired information via a computer communications network, searching for and reading from the fresh fish information database the fresh fish information that conforms to the selection conditions, and transmitting to said parties desiring fresh fish information the fresh fish information that was read out from the server.

Another fundamental embodiment of this invention is a method of providing fresh fish distribution support information, wherein information pertaining to fresh fish is collected and processed via a computer communications network and provided as distribution support information via a computer communications network, said method comprising the steps of guiding fresh fish producers to have them input fish catch microdata via a computer communications network, converting the fish catch microdata input and collected from fresh fish producers and containing a fresh fish identification tag code to database format and recording and storing it on a server as at least part of a fresh fish information database, attaching to the body of an individual fish a fresh fish identification tag with a fresh fish identification tag code, guiding parties desiring fresh fish background information to have them input the fresh fish identification tag code attached to the body of an individual fish via a computer communications network, searching for and reading out the relevant fish catch microdata from the fresh fish information database with the fresh fish identification tag code as a link code, and transmitting the fresh fish information containing at least a portion of the fish catch microdata read out from the server to the party desiring the fresh fish information.

Yet another fundamental embodiment of this invention is a method of providing fresh fish distribution support information, wherein information pertaining to fresh fish is collected and processed via a computer communications network and provided as distribution support information via a computer communications network, said method comprising guiding fresh fish producers to have them input fish catch microdata via a computer communications network, analyzing data based on the fish catch microdata input and collected from producers and generating fresh fish forecast data, converting this fresh fish forecast data to database format and recording and storing it on a server as at least part of a fresh fish information database, guiding parties desiring fresh fish information to have them input selection conditions for the desired information via a computer communications network for, searching for and reading from the fresh fish database the fresh fish forecast information that conforms to the selection conditions, and transmitting to said parties desiring fresh fish information the fresh fish forecast information that was read out from the server.

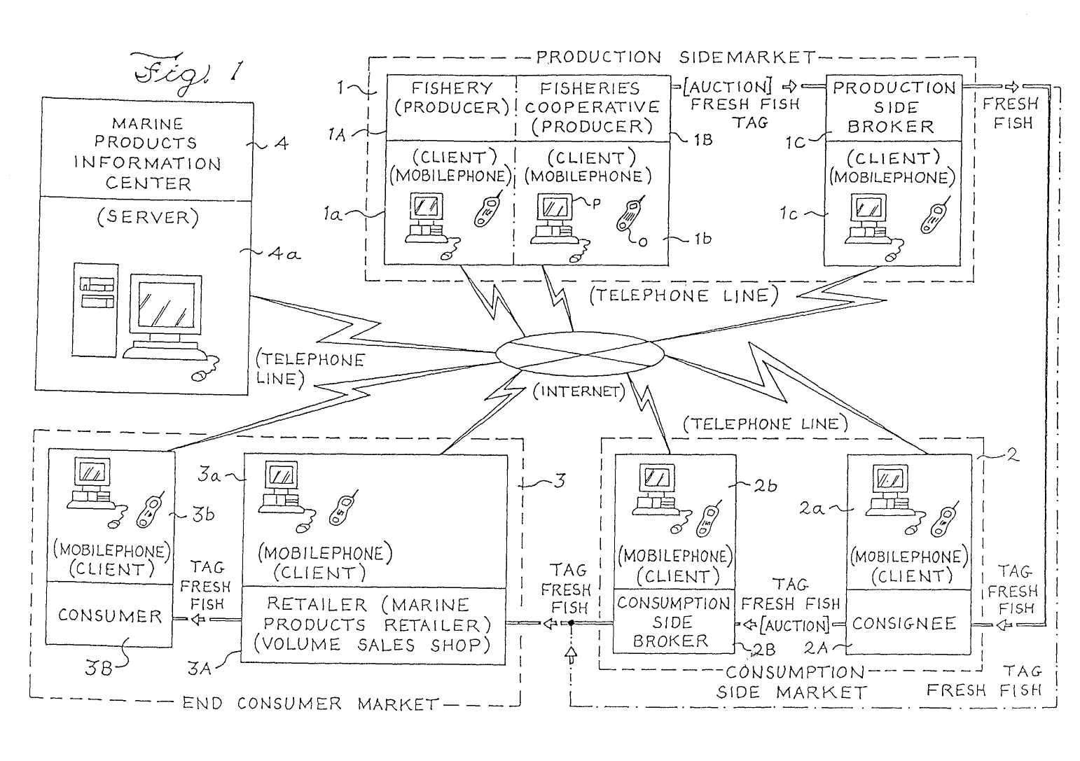

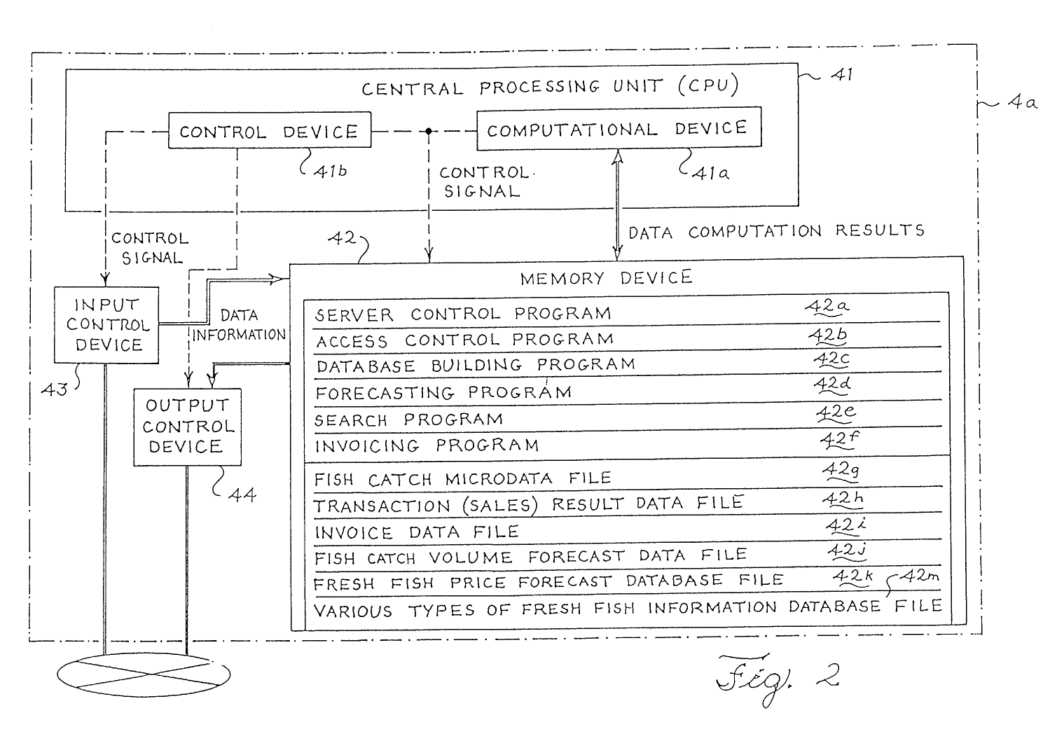

An example of this invention is described below with reference to FIG. 1 through FIG. 14. FIG. 1 is a block diagram showing the schematic structure of a system providing fresh fish distribution support information. In FIG. 1, 1 is the production side market, 2 is the consumption side market, 3 is the end consumer market, and 4 is the Marine Products Information Center (provisional name). The production side market 1 includes the fishery (producer) 1A, the fisheries cooperative (producer) 1B to which the fisheries belong, and the production side broker 1C. The production side market 2 includes the consignee 2A and the consumption side broker 2B. The end consumer market 3 includes retailers 3A such as marine products retailers and volume sales shops, as well as general consumers 3B.

The fishery 1A, the fisheries cooperative 1B, the production side broker 1C, the consignee 2A, the consumption side broker 2B, the retailer 3A, and the consumer 3B are all equipped, respectively, with data terminals 1a, 1b, 1c, 2a, 2b, 3a, and 3b, such as a client (personal computer) P or a mobile phone Q, and the Marine Products Information Center 4 is equipped with a server (computer) 4a. Also, the data terminals 1a, 1b, 1c, 2a, 2b, 3a, and 3b of the fishery 1A, the fisheries cooperative 1B, the production side broker 1C, the consignee 2A, the consumption side broker 2B, the retailer 3A, and the consumer 3B and the server of the Marine Products Information Center 4 are connected to each other via phone lines and the Internet, to form a computer network system.

Of course, the production side market 1, the consumption side market 2, and the end consumer market 3 exist in plurality, and in each of these markets 1, 2, and 3, the fishery 1A, the fisheries cooperative 1B, the production side broker 1C, the consignee 2A, the consumption side broker 2B, the retailer 3A, and the consumer 3B exist in plurality, but in order to simplify the description in FIG. 1, the fisheries, fishing co-ops, production side brokers, consignees, consumption side brokers, retailers, and consumers in each of these markets are each represented by a single entity in the drawing. Furthermore, the server 4a can be distributed to a plurality of sites, and some of the server functions can be assigned to a specified client P.

In the production side market 1, the fresh fish that are caught and landed by the fishery 1A are sold to the production side broker 1C by auction via the fishing co-op 1B. The production side broker 1C contacts the consumption side market at each locale and sends the fish to the most advantageous consumption side market 2, and the fish are sold to the consumption side broker 2C by auction via the consignee 2A in the consumption side market 2. The fresh fish sold to the consumption side broker 2B are sold wholesale to a retailer 3A of the end consumer market 3, and the consumer 3B purchases the fresh fish from the retailer 3A.

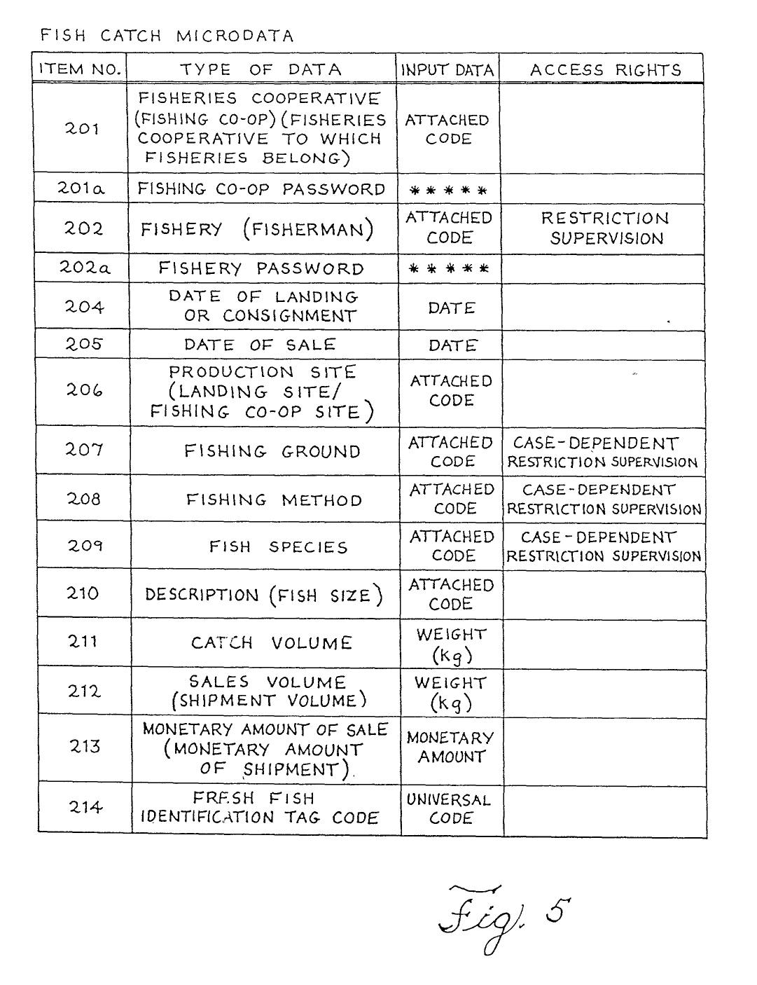

Fish catch microdata and fish transaction (sales) result data are generated in the series of transactions from the catching and landing of the fish to the purchase by the consumer. The fish catch microdata are the fish catch (or landing) data of each individual fisherman, data relating to each fish that is caught (individual fish), and, as shown in an example in FIG. 5, they include data such as the name of the fishery (fisherman), the name of the fishing co-op, landing date, sales date, production site, fishing area, fishing method, species of fish, description of the fish, volume of the catch, volume sold, monetary amount of sale, and fresh fish identification tag code. Since the fish catch microdata are generated up to the conclusion of the auction at the production side market, they are completed by the producer, that is to say, by the fishery 1A or the fishing co-op 1B.

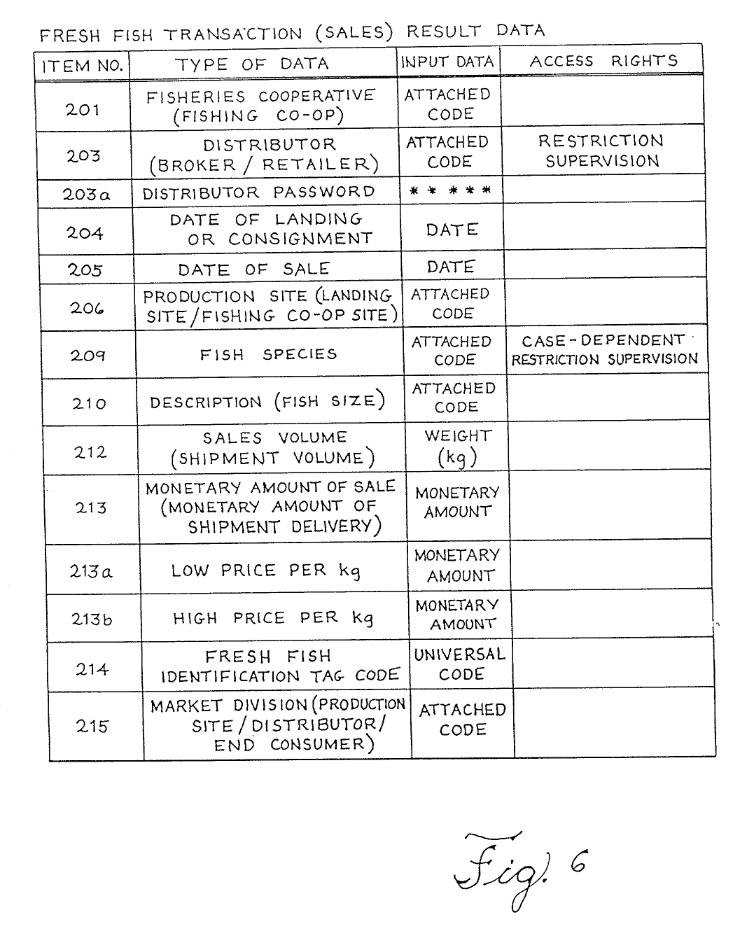

The fresh fish transaction (sales) result data (transaction result data) are the transaction result data of each of the individual distributors (brokers and retailers), data relating to individual fish, and, as shown in an example in FIG. 6, they include data such as the name of the distributor, the name of the fishing co-op, landing date, sales date, production site, species of fish, description of the fish, sales volume, monetary amount of sale, low price per kg, high price per kg, fresh fish identification tag code, and transaction market. The fresh fish transaction (sales) result data are generated when trading is completed at each market, and completed by each distributor.

As shown in FIG. 1, the fish catch microdata and the fresh fish transaction (sales) result data are input into the server 4a of the Marine Products Information Center 4 from the data terminal 1a or 1b of the fishery 1A or the fishing co-op 1B and from the data terminals 1c, 2a, 2b, and 3a of the distributors, via phone lines and the Internet.

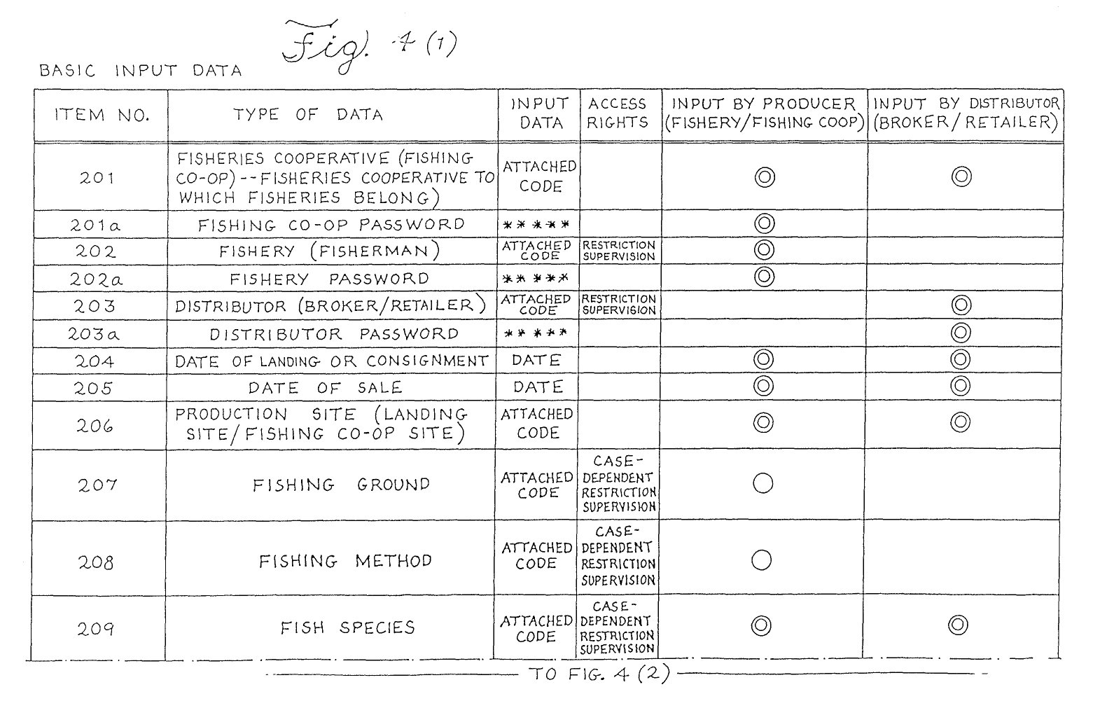

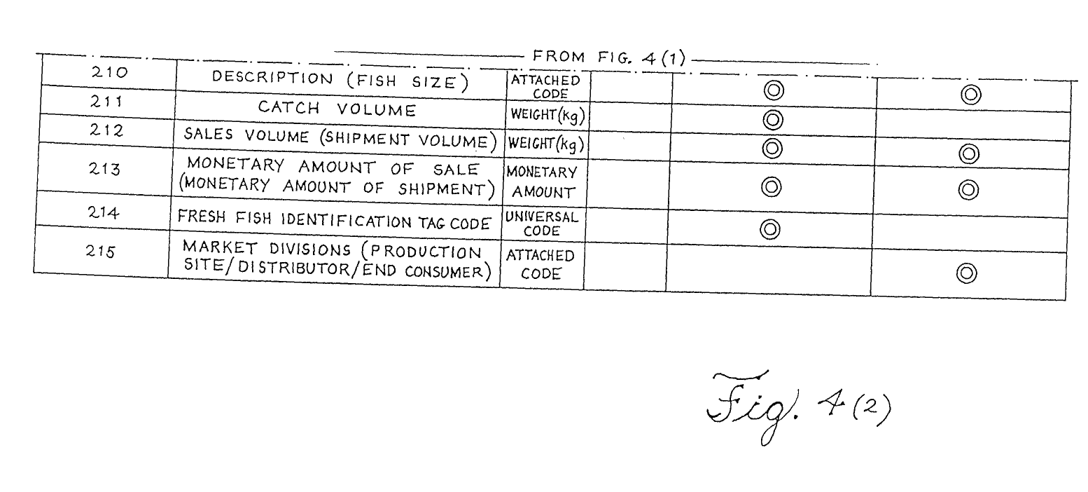

As shown in the example of basic data input items entered into the server 4a by the producer and distributor shown in FIG. 4, the password of the inputter (identification code), i.e., the fishing co-op password, the fishery's password, and the distributor's password are included as a security measure for information management. Furthermore, when the fresh fish information is provided, the individual fisheries or distributors who provide the data must prevent the leaking of certain personal data, so access rights restriction is implemented to prevent access to fishery codes and distributor codes by persons other than these individuals themselves. Moreover, in cases where there is certain data pertaining to the fishery or the distributor, access rights restriction is implemented for this data.

In addition, the fresh fish identification tag code is a unique label for identifying each of the fresh fish, and it is a code that can be read electronically, making it possible to connect the fish catch microdata to each of the individual fish, while they are being auctioned off en masse at the production side market 1. The fresh fish identification tag with a fresh fish identification tag code is attached to each fish, and the tagged fish reaches the consumer via the market. The distributors and consumers can know the background information for the fish, based on data contained in the fish catch microdata of the fish, with the fresh fish identification tag code of the fresh fish identification tag attached to the fresh fish as a key code. It should be noted that since there are many cases in which catch is landed in large quantity simultaneously in a plurality of sites, a universal code is used as the fresh fish identification tag code, thereby making it possible to attach the fresh fish identification tag with the fresh fish identification tag code to the fish at the same time as they are landed at various sites.

Among the basic input data, the data included in the fish catch microdata are entered by the fresh fish producers (fisheries or fishing co-ops), and the data included in the fresh fish transaction (sales) result data are entered by the distributors. That is to say, the item data marked with a circle (a double circle indicates a high level of importance) in the producer input column of FIG. 4 are entered by the producers, and the item data marked with a circle in the distributor input column are entered by the producers. In other words, the basic input data entered by the producers and summarized in FIG. 5 is the fish catch microdata, and the basic input data entered by the distributors and summarized in FIG. 6 is the fresh fish transaction (sales) result data. It should be noted that the fishery's password and the fishing coop's password are different in nature and are not originally included in the fish catch microdata, but since they are entered by the fisheries and fishing co-ops themselves, they are included with the list of fish catch microdata of FIG. 5. The same applies to the distributor password included in the list of fresh fish transaction (sales) result data in FIG. 6.

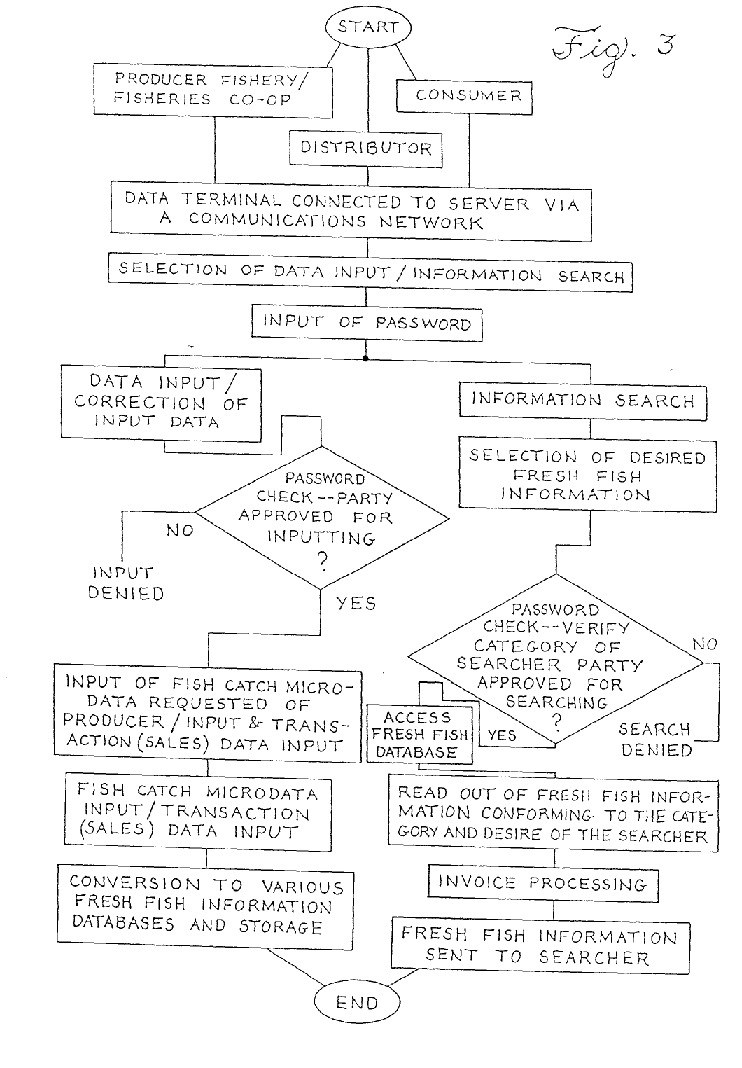

FIG. 2 shows the schematic structure of the server 4a installed at the Marine Products Information Center 4, and, as is well known, the server 4a is formed from a central processing unit (CPU) including a computational device 41a and a control device 41b, a memory device 42, an input control device 43, and an output control device 44. The input control device 43 and the output control device 44 are connected to the Internet. Not only is a server control program 42a installed in advance in the memory device 42, but also, an access control program 42b, a database building program 42c, a forecasting program 42d, a search program 42e, and an invoicing program 42f are installed in advance, and a fish catch microdata file 42g, a fresh fish transaction (sales) result data file 42h, as well as various fresh fish database files 42m generated through data processing with the above programs, an invoice database file 42i, a fish catch forecast database file 42j, a fresh fish price forecast database file 42k, and the like, are installed in memory.

The server control program 42a is the main program that operates the server 4a as a whole. The database building program 42c is a program utilizing the CPU 41 in converting the fish catch microdata entered into the server 4a or group data thereof (e.g., production site group data with a plurality of fish catch microdata organized as data for the region as a whole by the fishing co-op) and fresh fish transaction (sales) result data to a fresh fish information database. The forecasting program 42d is a computational program utilizing the CPU 41 in producing fish catch forecast data and fresh fish price forecast data from prior fish catch microdata accumulated in the memory device 42. The search program 42e is a search program for reading from various fresh fish databases stored in the memory device 42, utilizing the CPU 41. The invoicing program 42f is a program a manager for processing invoices for for-fee information, after a determination is made whether certain fresh fish information is free of charge or is for a fee, utilizing the CPU 41, before sending the information read out as a result of searching to the party desiring the information. The access control program is a program utilizing the CPU 41, so that fish catch microdata and fresh fish transaction (sales) result data are entered into the server 4a by the true producer or distributor (person authorized to enter data), and to prevent unauthorized access to the fresh fish information database on the server 4a Next, the method of providing fresh fish distribution information of the present invention is described with reference to the flowchart of FIG. 3. When any of the data terminals 1a, 1b, 1c, 2a, 2b, 3a, and 3b of the producers (fisheries, fishing co-ops) 1A and 1B, the distributors (brokers, consignees, retailers) 1C, 2A, 2B, and 3A or the consumer 3B is connected to a server, for example, when the data terminal 1b of the producer (co-op) 1B for inputting fish catch microdata to the server 4a of the Marine Products Information Center 4 via the Internet, an opening message is sent from the output control device 44 of the server 4a to the display of the data terminal 1b.

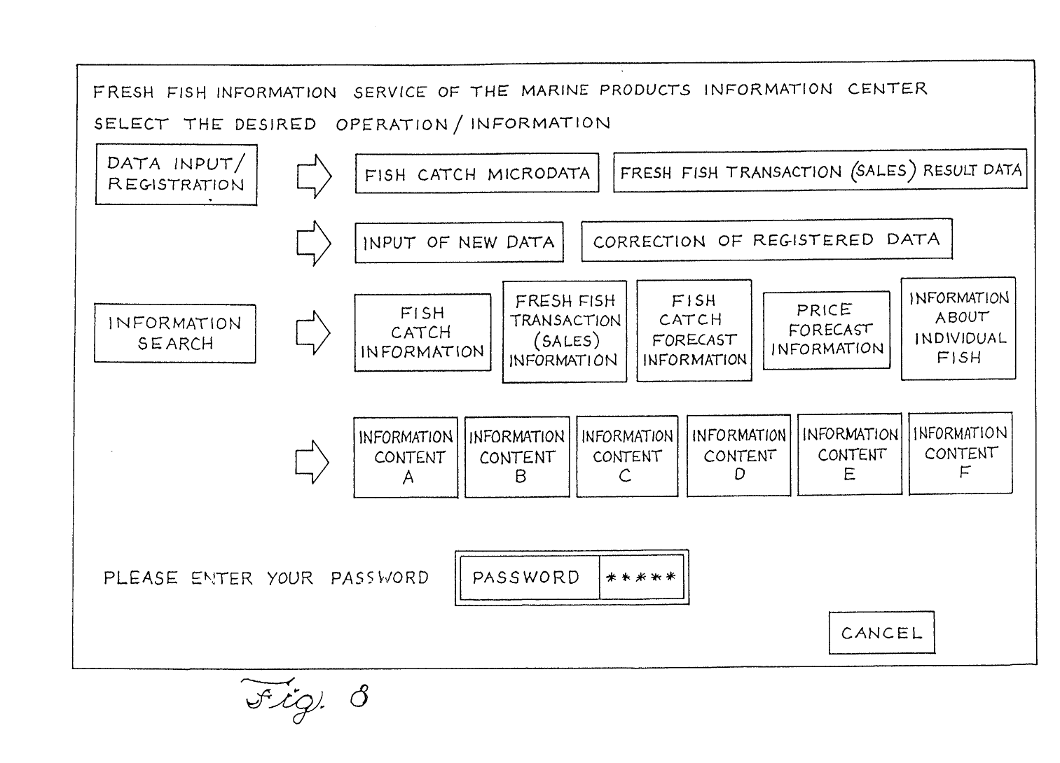

The format of the opening message can, for example, be that shown in FIG. 8. Accordingly, the producer 1B selects an operation on the screen of the opening message. In this case, when “Data input/registration” is selected, “Fish catch microdata” and “New data input” (or “Correction of registered data”) are displayed, and when the password of the producer 1B is entered, “OK” is displayed. This selection information is input to the server 4a through the input control device 43 of the server 4a, and enters the flow of data input. First, a determination is made as to whether the party is authorized to input data, based on the input password. For example, if “Fresh fish transaction (sales) data” is designated in the aforesaid operation selection procedure, and if it is determined that the producer 1B is not authorized to enter “Fresh fish transaction (sales) data,” then the subsequent data input operation is denied. Thus, the input of false data by unauthorized parties is prevented, and tampering with data stored in the server 4a is prevented.

Once the producer 1B is recognized as authorized to enter data, then a screen (data) is transmitted that guides the input of fish catch microdata to the display of the data terminal 1b. An example of the format of the fish catch microdata input-guiding screen is the fish catch microdata list screen shown in FIG. 5. All fish catch microdata is input to the server 4a through the input control device 43, when the producer 1B enters the various data in the input data column of this list. Then, the fish catch microdata input to the server 4a is stored in a fish catch microdata file of the memory device 42, and it is utilized in searching for various fresh fish information and in building a fresh fish information database. It should be noted that when distributors wish to input and register fresh fish transaction (sales) result data in the server 4a, a list screen (data) that guides the input of fresh fish transaction (sales) data, shown as an example in FIG. 6, is transmitted by selecting “Fresh fish transaction (sales) data” on said opening message screen, and, following the same step as when fish catch microdata is input, the fresh fish transaction (sales) data is input to the server 4a and stored in a transaction (sales) data file of the memory device 42.

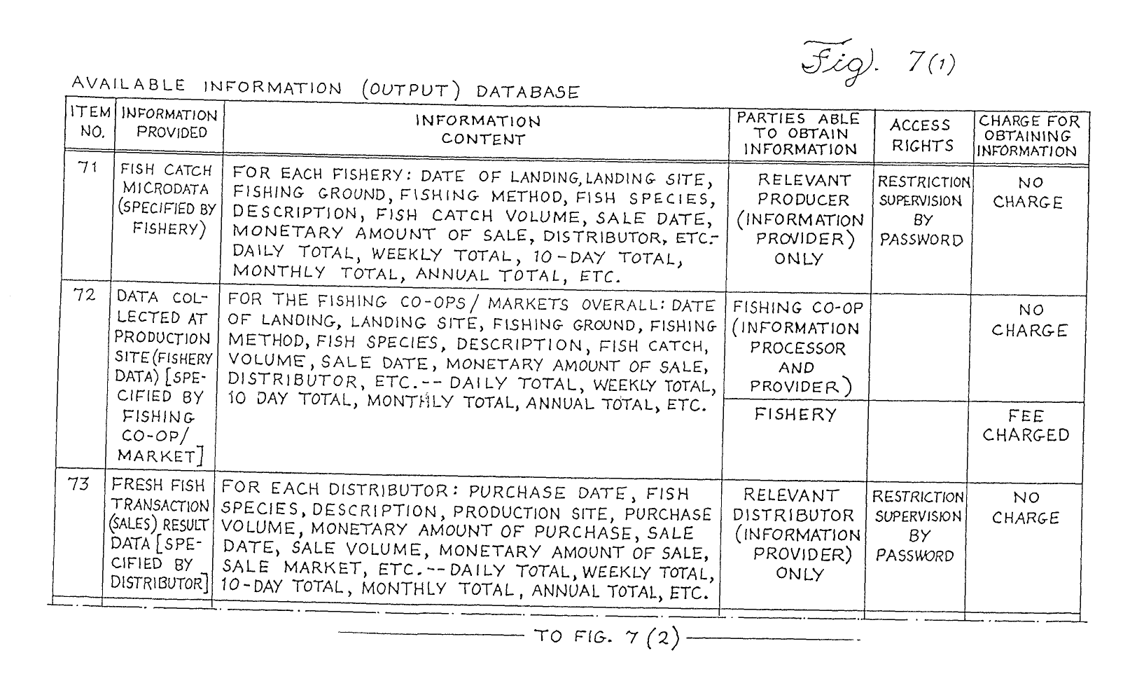

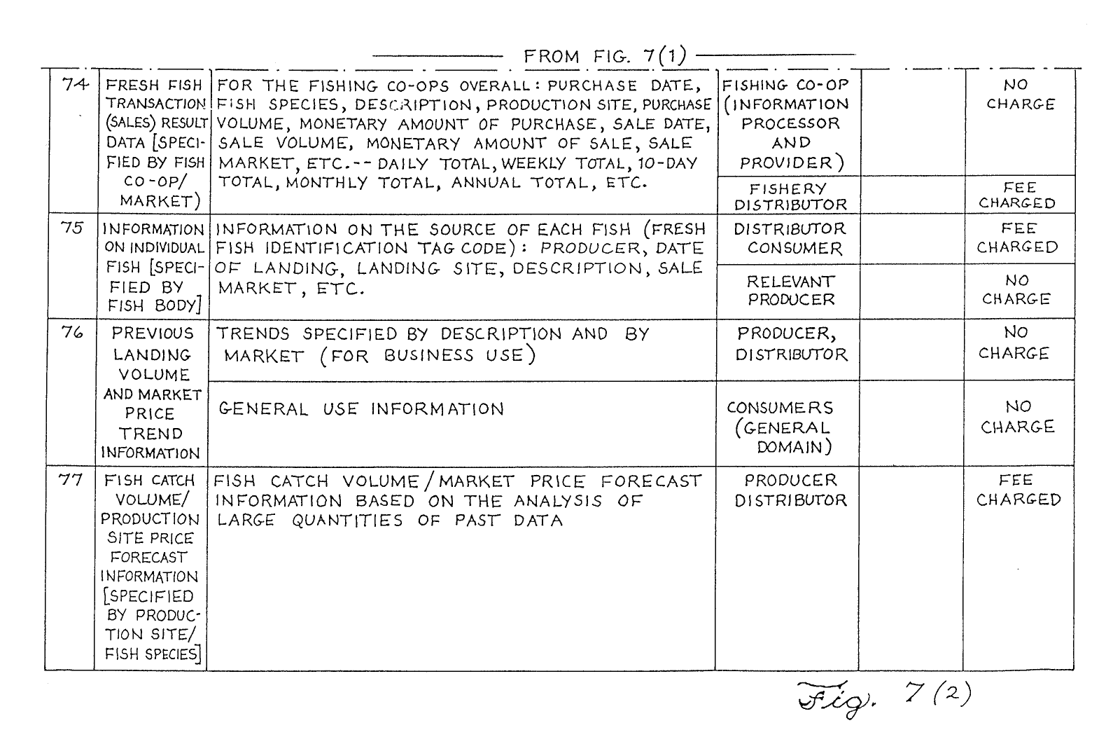

Following is a description of the case where the desired fresh fish information is obtained by accessing a database stored on the server 4a. Either a producer 1A, 1B, a distributor 1C, 2A, 2B, 3A, or a consumer 3B can be a party desiring fresh fish information (data searcher). First, “Information search” is selected on the opening message screen shown in FIG. 8, and as a condition for the information that is sought, the type of information (fish catch information, fresh fish transaction (sales) information, etc.) and the content conditions are designated, and when the password is indicated and “OK” is displayed, the data search begins. As shown in the available information (output) database list of FIG. 7, the types and content of data that can be designated are diverse, and the desired fresh fish information can be selected by referring to this list.

Since the databases stored on the server 4a are based on fish catch microdata and fresh fish transaction (sales) result data that were originally personal data, which are data for limited public access, and can only be obtained by a designated person, they are separated from ordinary data for public disclosure. Furthermore, since much of the fresh fish information is very valuable and effective for business purposes, the data offered at no cost is separated from the data offered for a fee, according to the content and recipient of the data. It should be noted that the available data (output) database list of FIG. 7 can be sent as data for guiding the input of selection conditions of the desired information, and displayed on the display of the data terminal of the party desiring fresh fish information (data searcher).

After the selection conditions for the desired information have been set, a password check is carried out, and the category of the party desiring fresh fish information (producer, distributor, or consumer) is verified, and a determination is made as to whether that party is authorized to search. The reason for verifying the category of the searcher is that there are cases in which the information is provided for a fee or for no fee depending on the category of the party desiring the fresh fish information (producer, distributor, or consumer), even if the identical fresh fish information is desired. Furthermore, the reason for determining whether or not the party is authorized to search is that it is necessary to determine whether or not access rights are to be denied in cases where data for which there is a desire for data with restricted access rights which is mixed with other data.

When the password check is completed, it becomes possible to search on various fresh fish information databases stored in the memory device 42, and fresh fish information is read out that conforms with the category of the party desiring the fresh fish information and the desired conditions. Also, in cases where providing the read out information is to be done for a fee, invoice processing is carried out for the specified cost, after which the desired fresh fish information is sent over the Internet to the party desiring the fresh fish information.

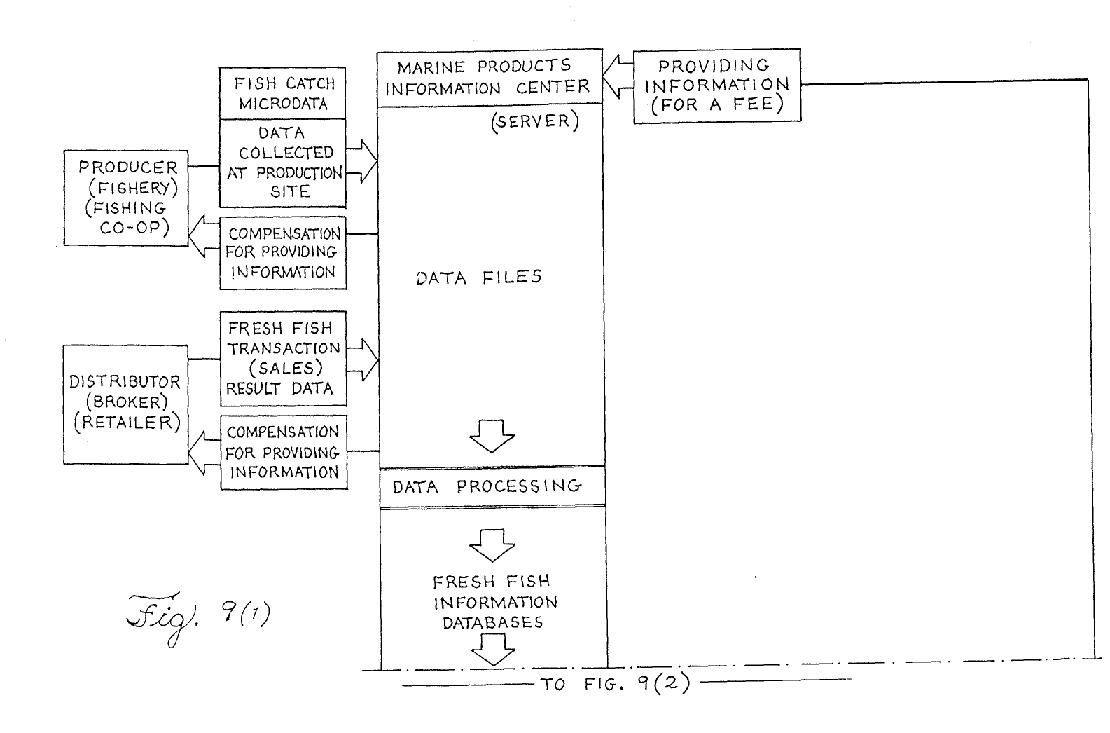

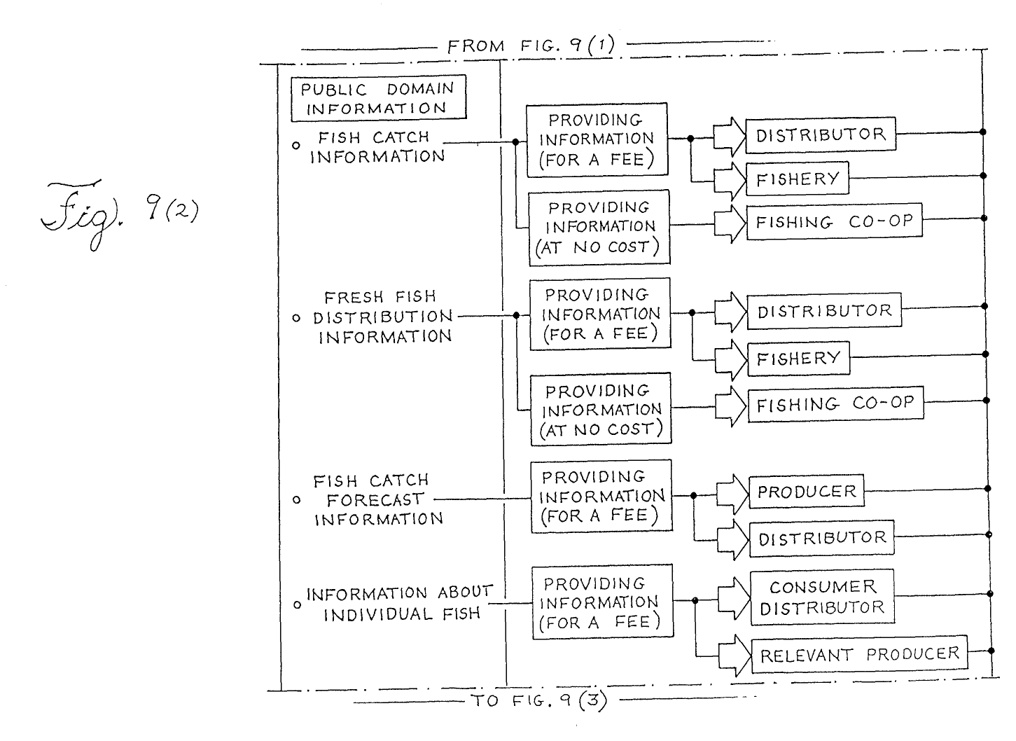

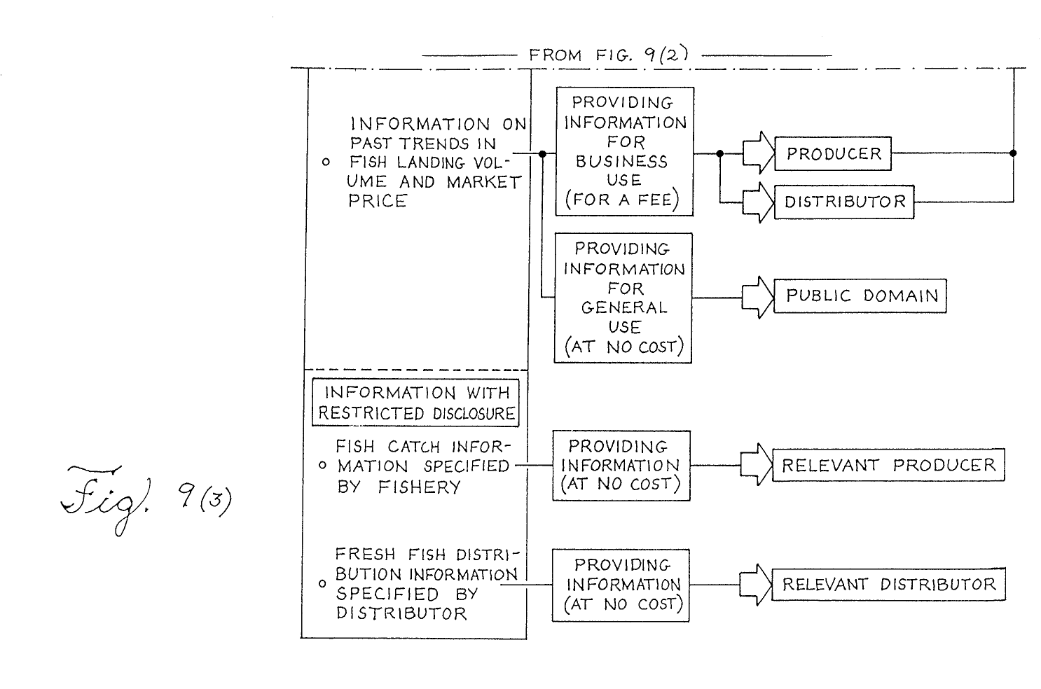

FIG. 9 shows the flow from the generation to the utilization of the fresh fish distribution support information provided in accordance with the present invention. As shown in FIG. 9, the moment-by-moment fish catch microdata from the producers reaches the server of the Marine Products Information Center, and is recorded as a data file in the memory device of the server. The input of production side group data with slightly processed fish catch microdata is also conceivable. At the same time, moment-by-moment fresh fish transaction (sales) result data from the distributors is input to the server of the Marine Products Information Center, and recorded in a data file in the memory device of the server.

It should be noted that due to technical advancements and the greater proliferation of memory devices, it is possible for a distributor to send fresh fish transaction (sales) result data to the server immediately after the completion of a transaction, either from the auction site or from the various sites of fresh fish transactions, and fisheries can also transmit fish catch microdata to the server from fishing boats on the fishing grounds at various points in time when fish are caught, considerably before the fish reach the production side market. Then, the fish catch microdata, the fresh fish transaction (sales) result data, and the fresh fish information based thereon, is broadly made public via a computer communications network, is highly valued as fresh fish distribution support information consisting of fish catch microdata and fresh fish transaction (sales) result data which is very rapidly stored on the server, because it can be broadly utilized among producers, distributors, and consumers. Moreover, it becomes possible to create a virtual market without waiting for the fresh fish to be physically delivered, by transmitting images of the fish that are caught and photographed with a digital camera, when the fisheries transmit the fish catch microdata to the server from fishing boats on the fishing grounds.

As shown in FIG. 9, the fish catch microdata and the fresh fish transaction (sales) result data collected on the server of the Marine Products Information Center are processed so as to generate various fresh fish information databases. The information contained in the fresh fish information databases includes ordinary data for public disclosure for which there are no particular restrictions on disclosure, as well as restricted data for which public access is restricted. Furthermore, even ordinary data for public disclosure is separated into data offered for a fee and data offered at no cost, depending on the content and the party to which it is disclosed. In addition, regarding data offered for a fee, recipients of the data are to pay a fee for searching for and using data, and the system is set up so that the fees are used to compensate the producers and distributors who provide valuable data. According to this invoicing system, the value of the information is confirmed by both parties, the transmission and exchange of fresh fish information greatly increases in the fresh fish distribution channels, including the fresh fish production site, thereby promoting streamlining and greater activity in the distribution process.

One of the essential points of this invention is that the fish catch microdata accumulated in the past is analyzed by data mining, leading to forecasting data for fish catch volume and fresh fish prices, and this forecasting data is provided as fresh fish distribution support information. Of course, as abundant fishing continues, an oversupply will result, which will bring down prices, so the catch during a specific period in the past and the cumulative volume thereof are a major factor in price determination. Accordingly, fish catch volumes and fish prices can be estimated by multiple regression analysis of past fish catch volumes.

In the example of this invention, the various factors affecting the unit prices for the principal species of fish are estimated based on previous fish catch microdata collected and stored on the server 4a from various sources, and the fish catch volumes for the principal descriptions are searched and extracted by time series, and the data for a specific number of days in the past is subjected to multiple regression analysis and time series analysis, resulting in a forecast value for the volume of fish to be landed and the unit price for the days of operation after the following day.

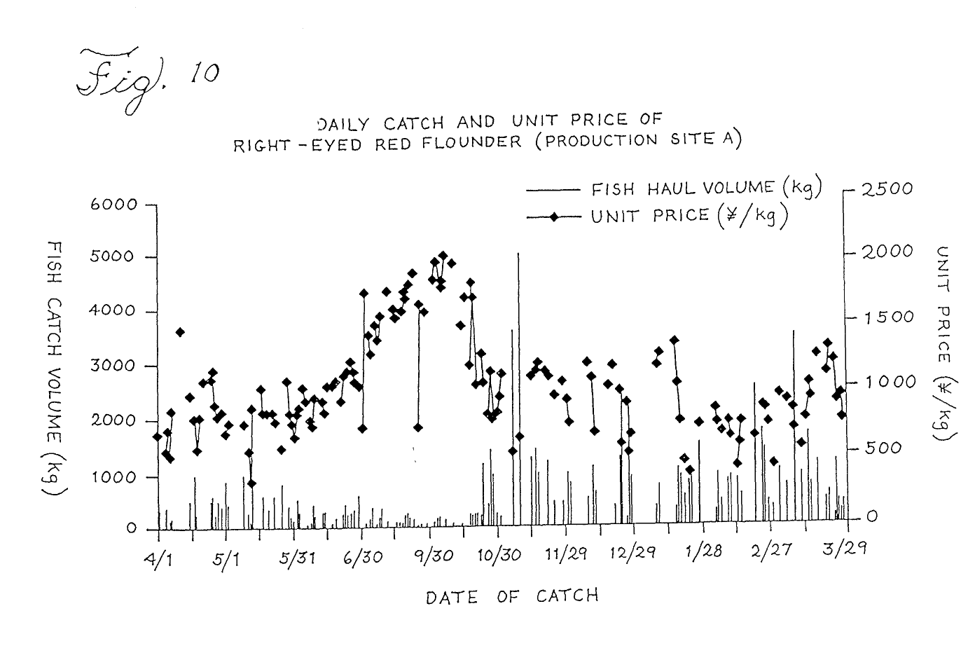

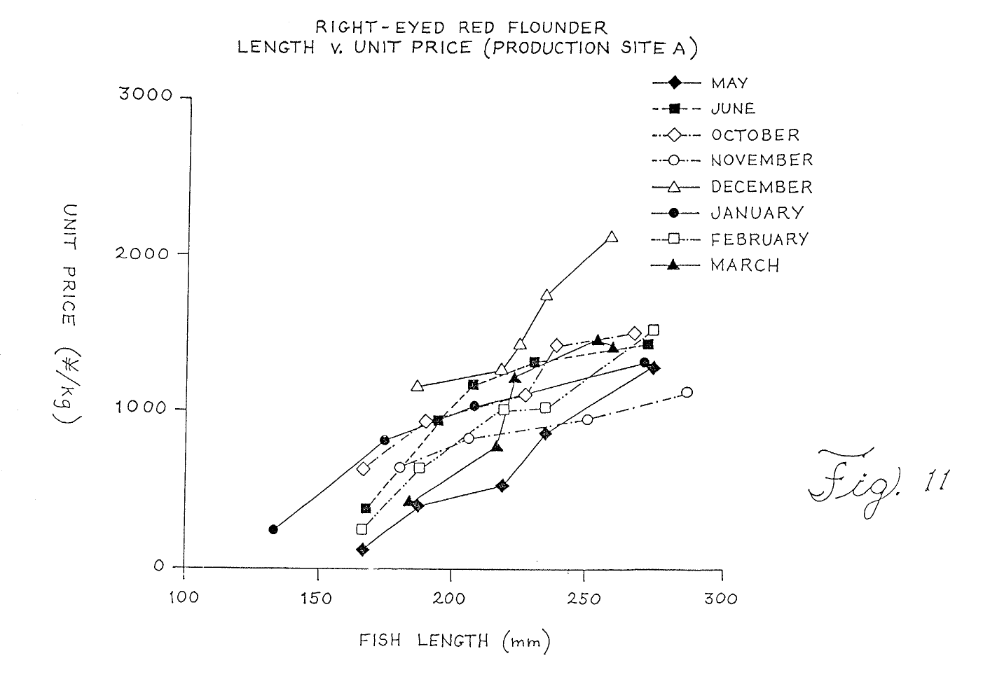

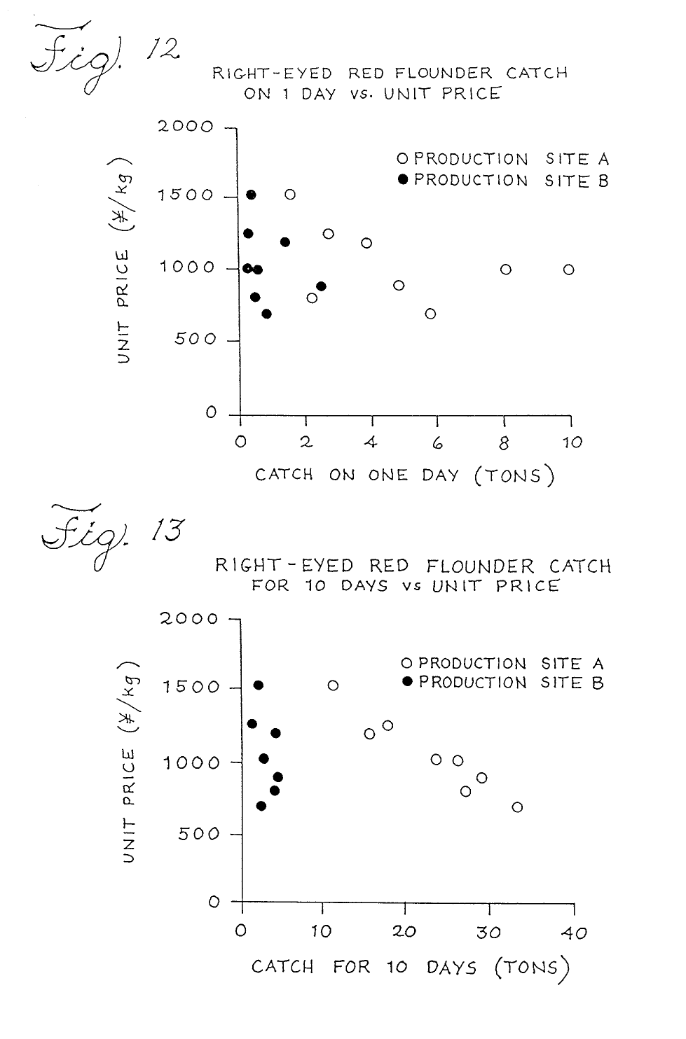

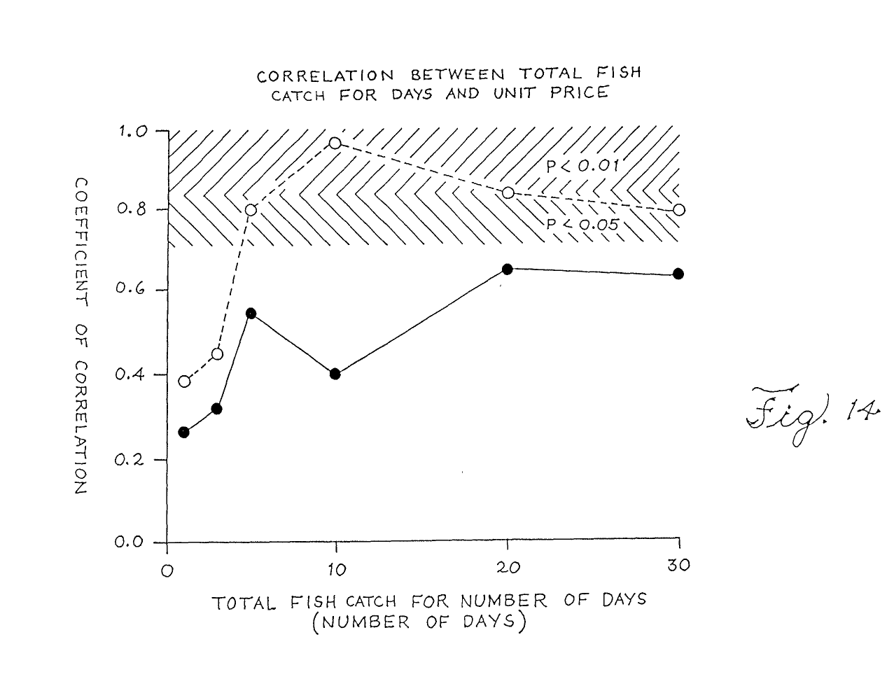

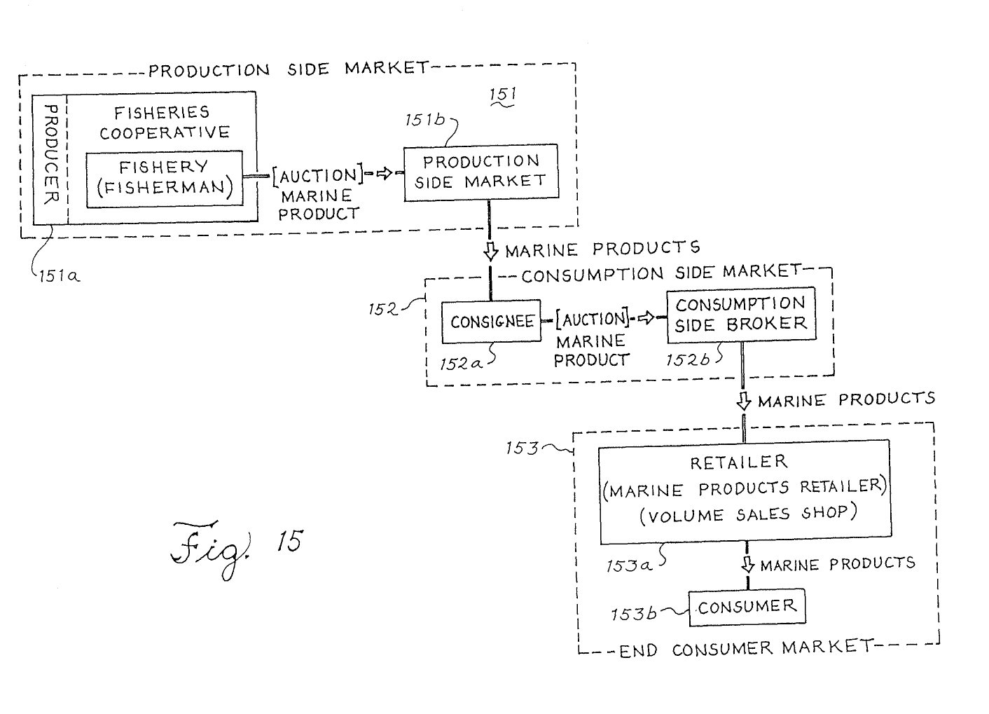

FIG. 10 through FIG. 14 illustrate an example for the right-eyed red flounder, one main species of fish caught by trawl net fishing. FIG. 10 is a graph showing fish catch volumes and unit prices for each day of catch. FIG. 11 is a graph showing the relationship between the length of the fish and the unit price. FIG. 12 is a graph showing the relationship between the fish catch volume and the unit price for 1 day. FIG. 13 is a graph showing the relationship between the fish catch volume and price for 10 days. As shown in FIG. 14, by analyzing these relationships, a high correlation can be found between the price and the fish catch volume for a 10-day period. Based the results of such quantitative analysis, it becomes possible to reduce risk in fresh fish transactions and to plan the purchase of fresh fish by utilizing the fish catch volume forecast data and fresh fish price forecast data. This will lead to greater demand for fresh fish.

As demonstrated by the example described above, the following advantageous effects can be expected in accordance with this invention.

(1) The management of marine resources is promoted by providing accurate fish catch information to fisheries.

(2) Profits are generated due to the fact that the high value-added fish catch microdata provided by fresh fish producers is processed and sold.

(3) Consumers can obtain guarantees of the source and quality of fish, based on the fish catch microdata.

(4) The determination of fair market prices is promoted by the fact that fish catch information (landing information) is rapidly and accurately provided to distributors.

(5) Distributors can plan for optimal purchasing by analyzing fish catch information (landing information), since they can easily understand the fish catch information (landing information).

(6) Objective and rational fresh fish transactions are promoted, and electronic transactions become more possible, since a certain level of fresh fish forecast information and price forecast information is provided based on past fish catch microdata.

Thus, in accordance with this invention, fisheries, distributors, and consumers can readily obtain fresh fish information at any time that reflects the actual state of affairs in each respective sector, and there are many situations in which this information can be utilized. That is to say, the fisheries can confirm at any time the status of their own fish catches and landings. Due to the fact that fresh fish producers and distributors can rapidly exchange accurate daily production site data and market transaction (sales) data, it promotes the rational and efficient distribution and commercial transactions that rapidly adjust to the true supply and demand situation, and contributes to maintaining the freshness of the fish. Furthermore, since distributors and consumers are able to trace and find out the background of the fish they have obtained (production site information), the information contributes to guaranteeing the origin and quality assurance of the fish, as well as health administration. Moreover, due to the fact that producers and distributors utilize objective fish catch forecast information and price forecast information based on past data, distribution risk can be reduced, and productivity can be enhanced in line with supply and demand, and marine resources can be protected more effectively.

1. A method of providing fresh fish distribution support information, wherein information pertaining to fresh fish is collected and processed via a computer communications network and provided as distribution support information via a computer communications network, said method comprising the steps of:
guiding fresh fish producers to have them input fish catch microdata via a computer communications network;
converting the fish catch microdata input and collected from the fresh fish producers to database format and recording and storing it on a server as at least part of a fresh fish information database;
guiding parties desiring fresh fish information to have them input selection conditions for the desired information via a computer communications network;
searching for, and reading from the fresh fish database, fresh fish information that conforms to the selection conditions; and
transmitting to said parties desiring fresh fish information the fresh fish information that was read out from the server.

2. A method of providing fresh fish distribution support information, wherein information pertaining to fresh fish is collected and processed via a computer communications network and provided as distribution support information via a computer communications network, said method comprising the steps of:
guiding fresh fish distributors to have them input fresh fish transaction result data via a computer communications network;
converting the fresh fish transaction result data input and collected from the fresh fish distributors to database format and recording and storing it on a server as at least part of a fresh fish information database;
guiding parties desiring fresh fish information to have them input selection conditions for the desired information via a computer communications network;
searching for, and reading from the fresh fish information database, fresh fish information that conforms to the selection conditions;
transmitting to said parties desiring fresh fish information the fresh fish information that was read out from the server.

3. A method of providing fresh fish distribution support information of claim 1, wherein a password of a fresh fish producer is needed to enter the fish catch microdata, and input is denied if the person entering the data is determined, based on the password, not to be a person authorized to enter data.

4. A method of providing fresh fish distribution support information of claim 2, wherein the password of a fresh fish distributor is needed to enter fresh fish transaction result data, and input is denied if the person entering the data is determined, based on the password, not to be a person authorized to enter data.

5. A method of providing fresh fish distribution support information of claim 1, wherein the fish catch microdata input and collected from the fresh fish producers is divided into limited access data and public access data, converted to database format and recorded and stored on a server as at least part of a fresh fish information database, and the addition of a password of a party desiring the fresh fish information is required in order to enter the selection conditions of the desired information, and a determination is made, based on the password, whether or not to provide fresh fish information containing limited access data to the party desiring the fresh fish information.

6. A method of providing fresh fish distribution support information of claim 2, wherein the fresh fish transaction result data input and collected from the fresh fish distributors is divided into limited access data and public access data, converted to database format and recorded and stored on a server as at least part of a fresh fish information database, and addition of a password of a party desiring the fresh fish information is required in order to enter the selection conditions of the desired information, and a determination is made, based on the password, whether or not to provide fresh fish information containing limited access data to the party desiring the fresh fish information.

7. A method of providing fresh fish distribution support information of claim 1, wherein the fish catch microdata input and collected from the fresh fish producers is divided into for-fee data and no-fee data, converted to database format, recorded and stored on a server as at least part of a fresh fish information database, and invoices for the fresh fish information that is searched and read from the fresh fish information database are processed, according to the category of a party desiring the fresh fish information.

8. A method of providing fresh fish distribution support information of claim 2, wherein the fresh fish transaction result data input and collected from fresh fish distributors is divided into for-fee data and no-fee data, converted to database format, recorded and stored on a server as at least part of a fresh fish information database, and invoices for the fresh fish information that is searched and read from the fresh fish information database are processed, according to the category of the party desiring the fresh fish information.

9. A method of providing fresh fish distribution support information, wherein information pertaining to fresh fish is collected and processed via a computer communications network and provided as distribution support information via a computer communications network, said method comprising the steps of:
guiding fresh fish producers to have them input fish catch microdata via a computer communications network;
converting the fish catch microdata input and collected from fresh fish producers and containing fresh fish identification tag codes to database format and recording and storing it on a server as at least part of a fresh fish information database;
attaching to each individual fish a fresh fish identification tag with a fresh fish identification tag code;
guiding parties desiring fresh fish background information to have them input a fresh fish identification tag code attached to each individual fish via a computer communications network;
searching for and reading out the relevant fish catch microdata from the fresh fish information database with the fresh fish identification tag code as a link code; and
transmitting the fresh fish information containing at least a portion of the fish catch microdata read out from the server to the party desiring the fresh fish information.

10. A method of providing fresh fish distribution support information of claim 9, wherein invoices are processed, according to the category of the party desiring the fresh fish information, for the fresh fish information that is searched and read from the fresh fish information database.

11. A method of providing fresh fish distribution support information, wherein information pertaining to fresh fish is collected and processed via a computer communications network and provided as distribution support information via a computer communications network, said method comprising the steps of:
guiding fresh fish distributors to have them input fresh fish transaction result data via a computer communications network;
converting the fresh fish transaction result data input and collected from the fresh fish distributors and containing fresh fish identification tag codes to database format and recording and storing on a server as at least part of a fresh fish information database;
attaching to each individual fish a fresh fish identification tag with a fresh fish identification tag code;
guiding parties desiring fresh fish background information to have them input the fresh fish identification tag code attached to each individual fish via a computer communications network;
searching for and reading out the relevant fresh fish transaction result data from the fresh fish information database with the fresh fish identification tag code as a link code; and
transmitting the fresh fish information containing at least a portion of the fresh fish transaction result data read out from the server to the party desiring the fresh fish information.

12. A method of providing fresh fish distribution support information of claim 11, wherein invoices are processed, according to the category of the party desiring the fresh fish information, for the fresh fish information that is searched and read from the fresh fish information database.

13. A method of providing fresh fish distribution support information, wherein information pertaining to fresh fish is collected and processed via a computer communications network and provided as distribution support information via a computer communications network, said method further comprising the steps of:
guiding fresh fish providers to have them input fish catch microdata via a computer communications network;
analyzing data based on the fish catch microdata input and collected from fresh fish producers to generate fresh fish forecast information;
converting the fresh fish forecast information to database format and recording and storing it on a server as at least part of a fresh fish information database;
guiding parties desiring fresh fish information to have them input selection conditions for said fresh fish forecast information via a computer communications network;
searching for and reading from the fresh fish database the fresh fish information that conforms to the selection conditions; and
transmitting to said parties desiring fresh fish information the fresh fish forecast information that was read out from the server.

14. A method of providing fresh fish distribution support information of claim 13, wherein the fresh fish microdata input and collected from fresh fish producers is analyzed by data mining to generate fresh fish forecast data.

15. A method of providing fresh fish distribution support information of claim 13, wherein the fresh fish forecast data is fish catch volume forecast data and/or production site price forecast data, and fresh fish forecast information is fish catch volume forecast information and/or production site price forecast information.

16. A method of providing fresh fish distribution support information of claim 13, wherein the fresh fish forecast information that is searched and read from the fresh fish information database is subjected to invoice processing.

17. A device for providing fresh fish distribution support information, a server being connected to data terminals of a plurality of fresh fish producers or fresh fish distributors via a computer communications network, said device comprising:
an output control device that outputs data guiding input of fish catch microdata or fresh fish transaction result data to the data terminals;
an input control device that inputs fish catch microdata or fresh fish transaction result data sent from the data terminals;
a CPU that converts said fish catch microdata or fresh fish transaction result data to various fresh fish information databases, operating according to a database building program installed in advance in a memory device; and
a memory device for storing said database building program and said fresh fish information databases.

18. A device for providing fresh fish distribution support information of claim 17, wherein the fish catch microdata or the fresh fish transaction result data includes a fresh fish identification tag code attached to a fresh fish identification tag which is attached to each individual fish.

19. A device for providing fresh fish distribution support information, a server being connected to data terminals of a plurality of fresh fish producers or fresh fish distributors via a computer communications network, said device comprising:
an output control device that outputs data guiding input of a password of a fresh fish producer and the fish catch microdata or data guiding input of a password of a fresh fish distributor and fresh fish transaction result data to the data terminals;
an input control device that inputs said password and fish catch microdata or fresh fish transaction result data sent from the data terminals;
a CPU that determines the qualifications of said fresh fish producer or distributor to input data, based on said password, operating according to an access control program installed in advance in a memory device; and
a memory device for storing said access control program and the fresh fish information databases based on said fish catch microdata or said fresh fish transaction result data.

20. A device for providing fresh fish distribution support information, a server being connected to data terminals of a plurality of parties desiring fresh fish information via a computer communications network, said device comprising:
an output control device that outputs data guiding input of selection conditions for the desired information to the data terminals and outputs to parties desiring fresh fish information conforming to these selection conditions;
an input control device that inputs selection conditions for the desired information sent from the data terminals;
a CPU that searches and reads out from the fresh fish information databases fresh fish information conforming to said selection conditions, operating according to a search program installed in advance in a memory device; and
a memory device for storing said search program and said fresh fish information databases.

21. A device for providing fresh fish distribution support information of claim 20, provided with a CPU that searches fresh fish information databases relating to fish catch microdata of individual fresh fish, based on fresh fish identification tag codes attached to the bodies of fresh fish that include the selection conditions of the desired information, and that reads out fresh fish information conforming to said selection conditions.

22. A device for providing fresh fish distribution support information of claim 20, a server being connected to data terminals of fresh fish producers or distributors as parties desiring fresh fish information via a computer communications network, said device comprising:
a memory device in which is installed in advance a forecasting program that analyzes and generates fish catch microdata; and
a CPU for reading out fresh fish forecast information, operating according to the forecasting program.

23. A device for providing fresh fish distribution support information, a server being connected to data terminals of a plurality of parties desiring fresh fish information via a computer communications network, said device comprising:
an output control device that outputs data guiding the input of the password of a party desiring fresh fish information and selection conditions for the desired information to the data terminals and that outputs to relevant parties desiring fresh fish information the fresh fish information conforming to the selection conditions;
an input control device that inputs a password and the selection conditions for the desired information sent from the data terminals;
a CPU that determines the category of the parties desiring fresh fish information and whether or not they are authorized to search, based on a password, according to an access control program installed in the memory device in advance, and that searches and reads out from a fresh fish information database the fresh fish information conforming to the selection conditions and the category of the party desiring fresh fish information, by means of a search program installed in a memory device in advance; and
a memory device in which are installed said access control program, a search program, and fresh fish information databases.

24. A device for providing fresh fish distribution support information of claim 23, provided with a CPU that searches fresh fish information databases relating to fish catch microdata of individual fresh fish, based on fresh fish identification tag codes attached to the bodies of fresh fish that include the selection conditions of the desired information, and that reads out fresh fish information conforming to said selection conditions.

25. A device for providing fresh fish distribution support information of claim 23, a server being connected to data terminals of fresh fish producers or distributors as parties desiring fresh fish information via a computer communications network, said device comprising:
a memory device in which is installed in advance a forecasting program that analyzes and generates fish catch microdata; and
a CPU for reading out fresh fish forecast information, operating according to the forecasting program.

26. A device for providing fresh fish distribution support information, a server being connected to data terminals of a plurality of parties desiring fresh fish information via a computer communications network, said device comprising:
an output control device that outputs data guiding the input of a password of a party desiring fresh fish information and selection conditions to the data terminals and that outputs to said party desiring fresh fish information the fresh fish information conforming to the selection conditions;
an input control device that inputs said password and the selection conditions for the desired information sent from the data terminals;
a CPU that determines the category of the parties desiring fresh fish information and whether or not they are authorized to search, based on a password, according to an access control program installed in the memory device in advance, and that computes invoices for the fresh fish information read out as described above, according to the category of the party desiring fresh fish information, by means of an invoicing program installed in advance in a memory device.

27. A device for providing fresh fish distribution support information of claims 26, a server being connected to data terminals of fresh fish producers or distributors as parties desiring fresh fish information via a computer communications network, said device comprising:
a memory device in which is installed in advance a forecasting program that analyzes and generates fish catch microdata; and
a CPU for reading out fresh fish forecast information, operating according to the forecasting program.
